(19) United States
(12) Patent Application Publication
(10) Pub. No.: US 2007/0051427 A1
(43) Pub. Date: Mar. 8, 2007

(54) Cooled clutch assembly and stump grinder incorporating the same

(75) Inventor: Jerry D. Wise, Doylestown, OH (US)

Correspondence Address: SAND & SEBOLT, AEGIS TOWER, SUITE 1100, 4940 MUNSON STREET, NW, CANTON, OH, 44718-3615, US

(73) Assignee: RAYCO MANUFACTURING, INC., Wooster, OH (US)

(21) Appl. No.: 11/220,210

(22) Filed: Sep. 6, 2005

(51) Int. Cl. A01G 23/08; A01G 23/06; B27M 3/00

(52) U.S. Cl. 144/24.12; 144/4.1; 144/334

(57) ABSTRACT

A stump grinder having a clutch assembly which includes a system for cooling the clutch bearings. The clutch assembly is mounted onto a crankshaft extending from the power source for the grinder and a fan is keyed to the crankshaft. The fan that is adapted to drive air over the clutch assembly during operation and thereby cool the same. More specifically, the fan drives air toward the clutch bearings to reduce the temperature thereof.

### BACKGROUND OF THE INVENTION

1. Technical Field

This invention generally relates to stump grinders. More particularly, the invention relates to a clutch assembly for a stump grinder. Specifically, the invention relates to a clutch assembly for a stump grinder which includes a means for cooling the bearings.

2. Background Information

Land frequently has to be cleared of trees in order to allow for fields to be planted, buildings to be built or for the construction of roads. Cutting the trees down is relatively easy compared to the removal of the stumps which remain after the trees have been felled. Stumps can be pulled out of the ground by tractors or other heavy machinery or can be ground into small wood chips by a stump grinder.

Many larger commercial stump grinders are available for use by building contractors and others who frequently need to remove large numbers of tree stumps. The operators of this type of equipment are experienced and know both how to use the machinery and how to correctly and efficiently remove tree stumps without damaging the machinery.

However, there is a growing market for smaller stump grinders that can be rented by individuals to remove the occasional tree stump. The renters of such devices are typically inexperienced in both stump removal and in the operation of heavy machinery. Consequently, in order to provide a stump grinder for such rental use, the manufacturers of these devices have incorporated many features typically found in machinery that the renter may be familiar with, such as lawnmowers. This is done to make it easier for this occasional user to operate the equipment. However, the inexperience of these users in removing stumps and in operating heavy equipment tends to result in incorrect operation of the equipment, overheating of the machines and consequent damage to various components in the stump grinders. The stump grinders therefore have to be frequently repaired and are consequently out of action for significant periods of time. This results in increased costs for operating the machines and loss of rental income to the rental company. Furthermore, the downtime for the grinders also results in the rental company having to carry more machines than would be necessary if the equipment did not need constant repair.

The smaller rental type stump grinders have clutch assemblies that are similar to those found in lawnmowers. The clutch assemblies in these grinders tend to have a high failure rate because of the heavy duty use of the machines and inexperience of the operators of such devices.

There is therefore a need in the art for a stump grinder that is less easy for an occasional operator to damage and therefore does not require frequent repair.

### SUMMARY OF THE INVENTION

The inventor of the instant device has recognized that one of the significant factors contributing to the high failure rate of rental-type stump grinders is the overheating of the clutch assembly during operation of the machine. The device of the present invention is a stump grinder that includes a clutch assembly which incorporates a cooling system for cooling the clutch assembly during operation. Specifically, the stump grinder of the present invention includes a fan that is adapted to drive air over the clutch assembly during operation and thereby cool the same. The fan has been shown to reduce the temperature of the clutch bearings by as much as 30%, thereby extending the life of the clutch assembly. The stump grinder of the present invention therefore tends to require less maintenance and downtime for repair and therefore tends to increase the rental income for companies which rent out these machines to occasional users.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a side elevational view of a stump grinder in accordance with the present invention;

FIG. 2 is a partial side elevational view of the stump grinder of FIG. 1 with a panel removed to show the details of the clutch assembly in accordance with the present invention;

FIG. 3 is a partially exploded perspective view of the engine and clutch assembly; and

FIG. 4 is a cross-sectional front view of the clutch assembly.

### DETAILED DESCRIPTION OF THE INVENTION

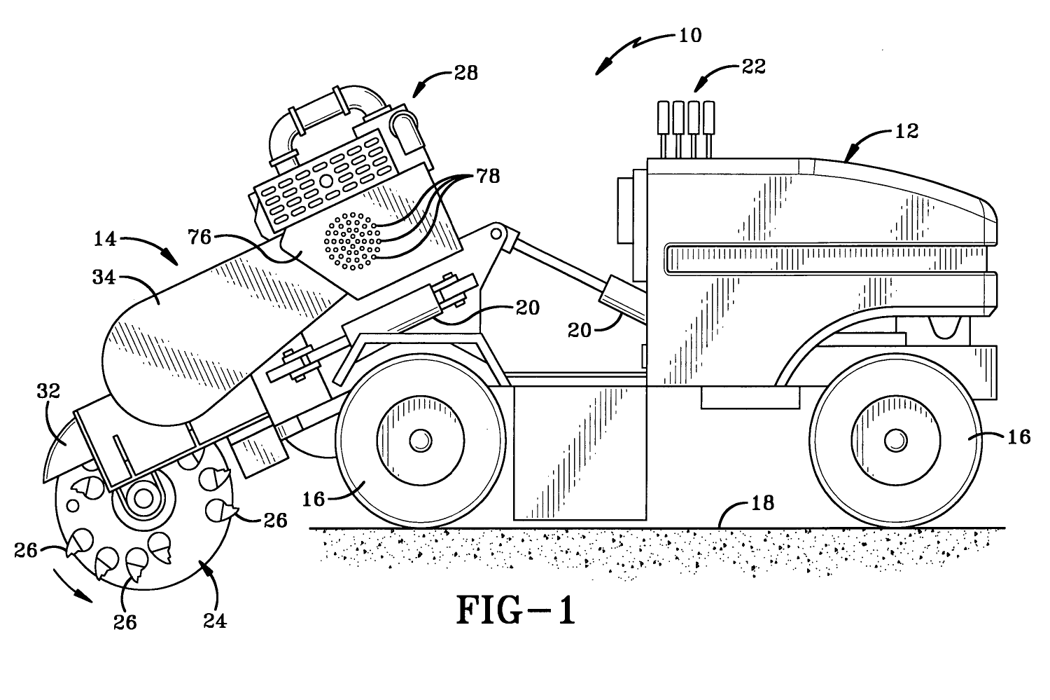

Referring to FIGS. 1 & 2, there is shown a stump grinder in accordance with the present invention and generally indicated at 10. Grinder 10 comprises a body portion 12 and a grinding portion 14. A plurality of wheels 16 are provided on body portion 12 and grinding portion 14 to enable grinder 10 to travel over a surface 18. Grinding portion 14 is mounted to body portion 12 in such a manner that grinding portion 14 can be vertically raised and lowered and can be moved horizontally from side to side. This movement is made possible by the provision of one or more hydraulic cylinders 20. The controls 22 for stump grinder 10 preferably are mounted on body portion 12. As will be understood by those skilled in the art, stump grinder 10 may include an engine (not shown) for moving body 12 over surface 18 or may include a handle (not shown) for an operator to manually move grinder 10. Body portion 12 may further include a seat (not shown) for an operator to sit in to drive the machine over surface 18.

Grinding portion 14 of stump grinder 10 includes a grinding wheel 24 mounted at the front end thereof. Grinding wheel 24 includes a plurality of cutting surfaces 26 for cutting into a tree stump when wheel 24 is moved into contact therewith. Grinding wheel 24 preferably is powered by a dedicated power source 28 such as a conventional combustion engine which is mounted on grinding portion 14. Grinding wheel 24 is operationally connected to power source 28 via the electric clutch assembly 30 in any manner known to those of ordinary skill in the art. Grinding wheel 24 is rotated, causing cutting surfaces 26 to bite into the tree stump (not shown) and grind the same away. The hydraulic cylinders 20 enable the operator to raise and lower grinding portion 14 and/or grinding wheel 24 and to move the same from side to side. This allows the operator to position wheel 24 correctly and to maneuver the same to engage the tree stump and cut small pieces away therefrom until the stump is totally ground away. Grinding portion 14 preferably includes a grinding wheel cover 32 and a deflection plate 34 to shield the operator from flying debris as the stump is ground down. Deflection plate 34 covers the linkage 36 (FIG. 2) between clutch assembly 30 and grinding wheel 24, thus protecting these components from flying wood chips as well.

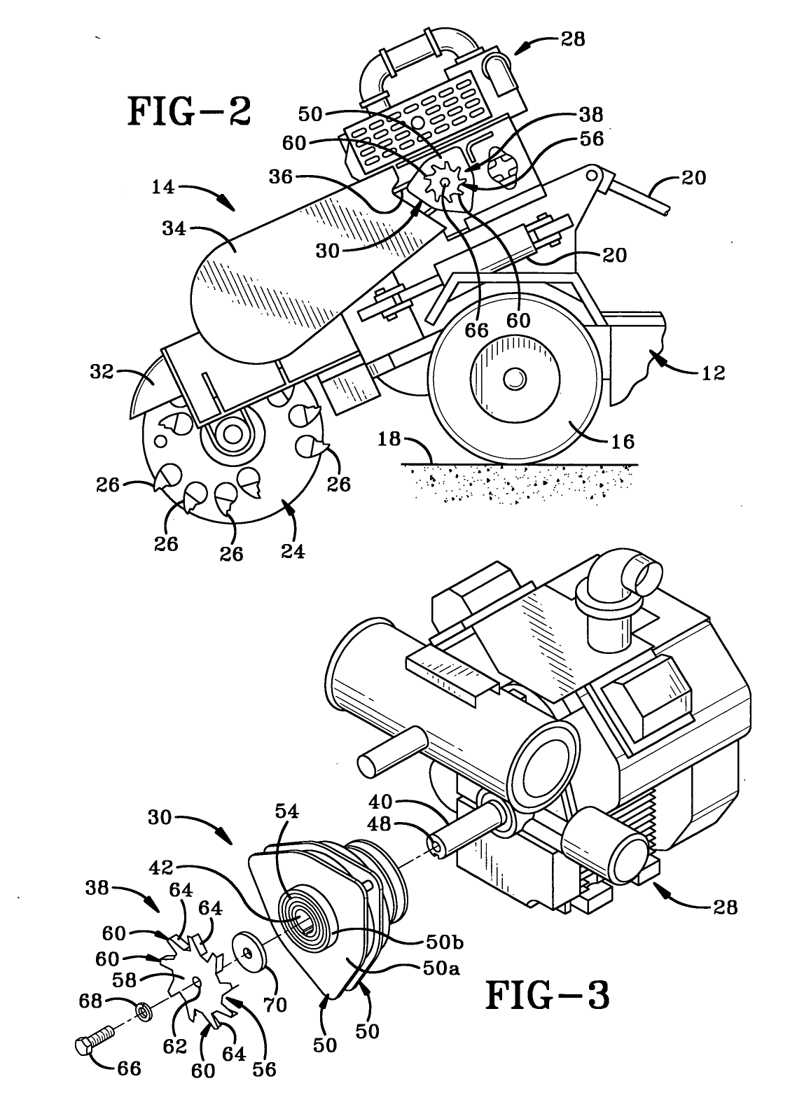

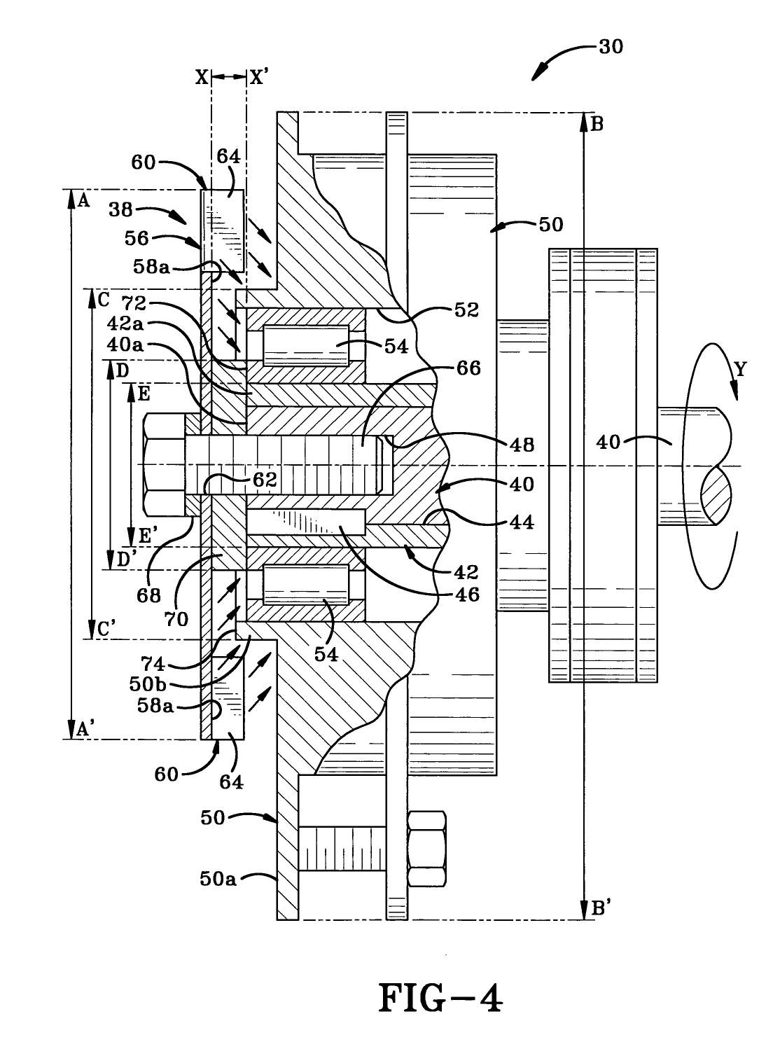

FIG. 3 shows a power source 28, which is a standard combustion engine; clutch assembly 30 and the clutch assembly cooling system 38 of stump grinder 10. Referring additionally to FIG. 4, crankshaft 40 extends outwardly from engine 28 and a tubular rotor 42 is fitted over crankshaft 40 so that crankshaft 40 lies within the bore 44 of rotor 42. A key 46 secures rotor 42 and crankshaft 40 together so that they rotate in unison whenever crankshaft 40 is driven by engine 28. Crankshaft 40 further includes an axial slot 48 that terminates at an end 40a of crankshaft 40.

Clutch assembly 30 includes clutch plates 50 which have a front end 50a and a nose portion 50b. Clutch plates 50 further include an axial central bore 52 therethrough. Crankshaft 40 and rotor 42 are received through bore 52 and are separated therefrom by clutch bearings 54. Bearings 54 allow rotor 42 and crankshaft 40 to rotate freely within bore 52. Clutch assembly 30 is engaged and disengaged in a manner which will be well known to those of ordinary skill in the art.

In accordance with a specific feature of the present invention, clutch assembly 30 is provided with a cooling system 38. As is shown in FIG. 4, cooling system 38 comprises a fan 56 which is secured to and rotates with crankshaft 40. Fan 56 has a disc-shaped body 58 having a plurality of fins 60 radiating outwardly away from a central aperture 62. Fins 60 further each include a flange 64 extending outwardly away from a rear surface 58a of body 58 and substantially at right angles thereto. It will be understood that fan 56 may be of any other desirable configuration without departing from the spirit of the present invention.

A threaded bolt 66 is inserted through a first washer 68, through aperture 62 in fan 56, through a second washer 70 and into threaded slot 48 of crankshaft 40. Fan 56 has an outer diameter A-A′ (FIG. 4) which is smaller than the outermost diameter B-B′ of clutch plate 50, but larger than the outermost diameter C-C′ of the nose portion 50b of clutch plates 50. Furthermore, washer 70 has a diameter D-D′ which is greater than the outer diameter E-E′ of rotor 42. Washer 70 does not therefore extend upwardly over the entire side surface of bearings 54. Washer 70 covers approximately one third of the side surface of bearings 54 as shown in FIG. 4. Fan 56 is positioned so that flanges 64 extend toward front end 50a of clutch plates 50 and any air moved by fan 56 is driven toward front face 50a of clutch plates 50 as is shown by FIG. 4. Fan 56 is separated from end 42a of rotor 42 by washer 70, whereby a space X-X′ separates fan 56 and outermost surface 72 of bearings 54. As may be seen from FIG. 4, bearings 54 are preferably recessed in nose portion 50b of clutch plate 50, such that the outermost surface 72 of the bearings 54 lies inwardly of outer surface 74 of nose portion 50b.

Clutch assembly 30 is covered with and protected by a plate 76 (FIG. 1) which includes a plurality of air holes 78 therein. Plate 76 may be formed as a portion of deflection plate 34 or may be a completely separate entity which interlocks with deflection plate 34. Plate 76 is disposed so that air holes 78 lie adjacent fan 56 when plate 76 is in position over clutch assembly 30.

In operation, power source 28 is engaged causing a rotation “Y” in crankshaft 40 (FIG. 4). Crankshaft 40 is keyed to rotor 42 and consequently rotor 42 also rotates in the direction of arrow “Y”. Fan 56 is fixedly secured by bolt 66 to crankshaft 40 and consequently fan 56 also rotates in unison with crankshaft 40 and rotor 42. As fan 56 rotates, air is sucked through holes 78 in plate 76 (FIG. 1) and is driven toward the front face 50a of clutch plates 50. Because washer 70 has a reduced diameter relative to that of the bore 52 of clutch plates 50, air drawn through air holes 78 is forced inwardly toward bearings 54 (shown by the arrows in FIG. 4). This forced air cools bearings 54 and the surrounding parts of the clutch plate 50 that it contacts. It has been found that including a fan 56 in clutch assembly 30 causes a reduction of around 30% in the temperature of bearings 54. This reduces the tendency of the bearings 54 to overheat and fail and the fan 56 thereby extends the life of the clutch assembly 30 and reduces the need for maintenance, repair and replacement of the same. It should be noted that because fan 56 is secured directly to crankshaft 40, fan 56 is driven by the engine 28 whether the clutch is engaged or disengaged.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A stump grinder for grinding tree stumps; the grinder comprising:
a body portion;
a grinding portion movably secured to the body portion;
a plurality of wheels mounted on at least one of the body and grinding portions for moving the grinder over a surface;
a grinding wheel mounted on the grinding portion and having a plurality of cutting surfaces thereon; the grinding wheel being adapted to engage a tree stump and cut portions thereof away;
a power source operationally connected to the grinding wheel to rotate the same;
a clutch assembly interposed between the power source and the grinding wheel; and
a cooling system mounted proximate the clutch assembly, whereby the clutch assembly is cooled at least during operation of the grinding wheel.

2. The stump grinder as defined in claim 1, wherein the cooling system comprises a fan mounted proximate the clutch assembly.

3. The stump grinder as defined in claim 2, wherein the power source includes a crankshaft and both the fan and clutch assembly are mounted on the crankshaft.

4. The stump grinder as defined in claim 3, wherein the fan is secured for rotation in unison with the crankshaft; and whereby the fan rotates both when the clutch assembly is engaged and when the clutch assembly is disengaged.

5. The stump grinder as defined in claim 3, wherein the fan is secured to the crankshaft in such a position that the clutch assembly is disposed between the fan and the power source.

6. The stump grinder as defined in claim 3, wherein the crankshaft includes an axial slot and the fan is secured to the crankshaft by a threaded bolt received within the axial slot.

7. The stump grinder as defined in claim 6, further comprising a washer disposed between the fan and an end of the crankshaft.

8. The stump grinder as defined in claim 7, wherein the crankshaft is received through a bore of a tubular rotor; and wherein the rotor has an outer diameter and the washer has a diameter; and wherein the diameter of the washer is greater than the outer diameter of the rotor.

9. The stump grinder as defined in claim 7, wherein the clutch assembly includes a clutch plate having an axial bore therethrough and said rotor and crankshaft are received through said clutch plate bore; and wherein a plurality of clutch bearings are disposed in the bore between the rotor and an interior wall of the clutch plate; and the clutch plate bore has an outer diameter; and wherein the diameter of the washer is smaller than the outer diameter of the clutch plate bore.

10. The stump grinder as defined in claim 2, wherein the fan comprises a disc-shaped body with a front surface and a back surface and having plurality of fins radiating outwardly from a central aperture therein; and wherein at least one of the fins includes a flange extending outwardly away from one of the front and back surfaces of the body.

11. The stump grinder as defined in claim 10, wherein the flange extends outwardly from the one of the front and back surfaces at substantially right angles thereto.

12. The stump grinder as defined in claim 11, wherein the flange on the fan extends toward an outer surface of the clutch assembly.

13. The stump grinder as defined in claim 13, wherein the body of the fan lies a spaced distance from the outer surface of the clutch assembly.

14. The stump grinder as defined in claim 1, further comprising a cover plate disposed on the grinder portion proximate the clutch assembly.

15. The stump grinder as defined in claim 14, wherein the cover plate defines a plurality of air holes therein.

16. The stump grinder as defined in claim 15, wherein the air holes are disposed so as to lie adjacent the fan when the cover plate is disposed proximate the clutch assembly.

17. A cooled clutch assembly for use in heavy machinery, the clutch assembly being adapted to be mounted on a crankshaft driven by a power source; and wherein the clutch assembly comprises:
a clutch plate; said clutch plate defining a central bore adapted to receive the crankshaft therethrough;
a tubular rotor disposed within the central bore of the clutch plate; the rotor being complementary sized to receive the crankshaft tightly therethough; whereby a channel is formed between the rotor and the clutch plate, said channel lying concentric about said rotor;
a key adapted to secure the rotor and crankshaft together;
at least one bearing disposed within the channel; the bearing lying in engagement with both the clutch plate and the rotor;
a fan adapted to be fixedly secured to an end of the crankshaft; whereby the fan rotates in unison with the crankshaft; said fan being adapted to be positioned so that the clutch plate lies intermediate the fan and the power source.

18. The clutch assembly as defined in claim 17, wherein the fan comprises a substantially disc-shaped member having a plurality of fins radiating outwardly from a central aperture.

19. The clutch assembly as defined in claim 18, wherein the fins further include flanges which are disposed substantially at right angles to a rear surface of the fan.

20. The clutch assembly as defined in claim 18, further comprising a washer disposed between the disc-shaped member of the fan and an end of the rotor, whereby the disc-shaped member of the fan lies substantially at right angles to the end of the rotor and a spaced distance away therefrom.

21. The clutch assembly as defined in claim 20, wherein the washer has a diameter and the rotor has an outer diameter and the clutch plate bore has an outer diameter; and wherein the washer diameter is smaller than the clutch plate bore's outer diameter and is larger than the rotor's outer diameter; whereby at least a portion of the bearing disposed within the channel between the rotor and the clutch plate are disposed radially outwardly relative to an outer perimeter of the washer.
